(19) United States
(12) Patent Application Publication
(10) Pub. No.: US 2010/0182142 A1
(43) Pub. Date: Jul. 22, 2010

(54) METHOD, SYSTEM AND COMPUTER PROGRAM OF ISSUING A TIRE PRESSURE DEVIATION WARNING

(76) Inventors: Martin Svedberg, Goteborg (SE); Urban Forssell, Linkoping (SE); Peter Lindskog, Linkoping (SE); Anders Stenman, Linkoping (SE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/531,685

(22) PCT Filed: Mar. 16, 2007
(86) PCT No.: PCT/EP2007/002367

§ 371 Date: Mar. 22, 2010

(51) Int. Cl. B60C 23/02

(52) U.S. Cl. 340/442

(57) ABSTRACT

The invention is directed to a system, a method and a computer program including program code for carrying out the method, when executed on a processing system, of the tire low pressure warning of a vehicle. The system comprises an input unit (3) adapted to receive a vehicle signal. It further comprises a determination unit (2,4,5) adapted to determine a tire pressure signal (P) indicative of a tire pressure deviation in the vehicles tire on the basis of the vehicle signal. Finally, it comprises a warning unit (10) adapted to issue a warning signal only after the tire pressure signal (P) has indicated a predetermined pressure deviation (ΔP₀) for a minimum period of time (ΔTₘᵢₙ).

### FIELD OF THE INVENTION

The present invention relates generally to the issuing of a tire pressure deviation warning signal and, in particular, to a method, a system, and a computer program for issuing such a signal.

### BACKGROUND OF THE INVENTION

Modern cars comprise electronic control systems such as anti-lock-braking systems (ABS), dynamic stability systems, anti-spin systems and traction control systems. Besides these active control systems there also exist driver safety information systems as road friction indicators and tire pressure monitoring systems which present to the driver information about driving and vehicle conditions.

In recent years, the tire pressure monitoring system has increasingly been of the type which determines lowering of the tire pressure based on indirect detection values of a modern vehicle, such as the wheel speed signals, etc. Statistical methods are applied to determine the probability of a puncture situation of a tire.

These indirect tire pressure monitoring systems use continuous approaches where low pressure warnings basically are allowed within a very short detection period. Some countries legally require a maximum time period within which a pressure monitoring system should issue an alarm until a tire pressure drop of a predetermined amount has been detected. For instance, the law FMVSS no. 138 in the United States specify this maximum period to be 20 minutes after the tire pressure has dropped 25% below a reference pressure level.

The general problem to be solved by the present invention is to improve the performance of an indirect tire pressure warning system and to reduce the possibility of issuing false warning alarms.

The problem will be solved by a method, a system and a computer program according to the independent claims. Further embodiments of the invention are disclosed in the dependent claims.

A first aspect of the invention is directed to a method of is issuing a tire pressure deviation warning for a vehicle's tire. The method comprises the steps of receiving at least one vehicle signal, determining a tire pressure signal indicative of a tire pressure deviation in a vehicle's tire on the basis of the vehicle signal, and issuing a warning signal only after the tire pressure signal has indicated a predetermined pressure deviation for a minimum time period.

Another aspect of the invention is directed to a system of issuing a tire pressure deviation warning for a vehicle's tire. The system comprises an input unit adapted to receive a vehicle signal, a determination unit adapted to calculate a tire pressure signal indicative of a tire pressure deviation in the vehicle's tire on the basis of the vehicle signal, and a warning unit adapted to issue a warning signal only after the tire pressure signal has indicated a predetermined pressure deviation for a minimum time period.

A further aspect of the invention is directed to a computer program including program code for carrying out a method, when executed on a processing system, of issuing a tire pressure deviation warning for a vehicle's tire. The method comprises the steps of receiving at least one vehicle signal, determining a tire pressure signal indicative of a tire pressure deviation in a vehicle's tire on the basis of the vehicle signal, and issuing a warning signal only after the tire pressure signal has indicated a predetermined pressure deviation for a minimum time period.

Embodiments of the invention will now be described, by way of example, and with reference to the accompanying drawings, in which:

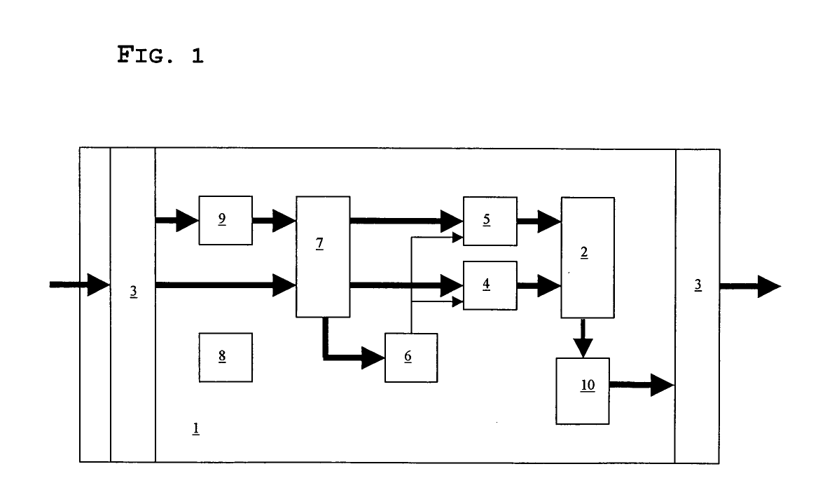

FIG. 1 schematically shows the structure of a system for issuing a tire pressure deviation warning signal according to the invention;

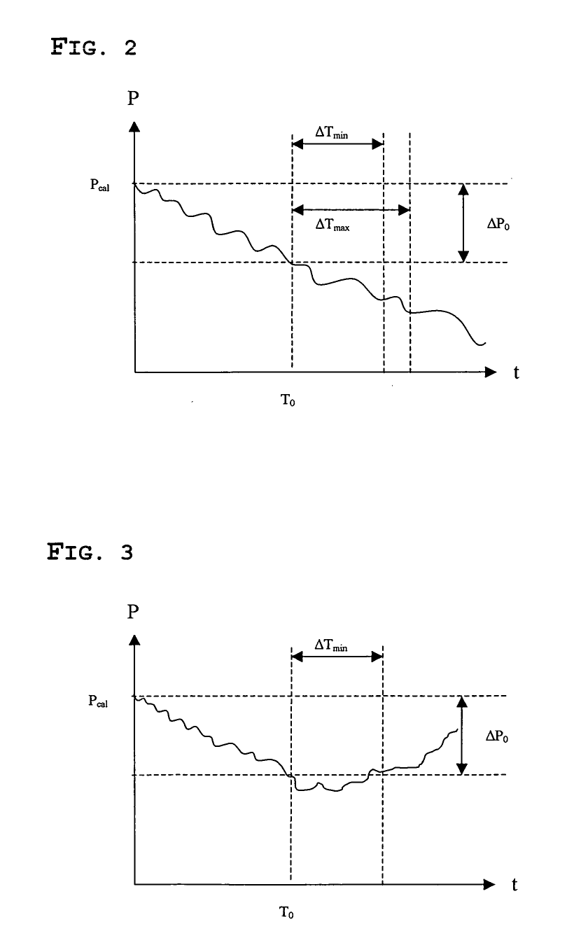

FIG. 2 shows an exemplified curve representing the variation in time of the tire pressure signal in order to explain the functioning of a warning unit according to the invention;

FIGS. 3 to 5 show further exemplified curves representing the variation in time of the tire pressure signal in order to explain the functioning of the warning unit according to the invention in exceptional situations.

### DETAILED DESCRIPTION OF THE PREFERRED EMBODIMENTS

Indirect tire pressure monitoring is a technique known to the person skilled in the art from general knowledge. Details of this technique are therefore only described as far as they directly concern the invention. The invention is provided for use in any kind of vehicle having at least one wheel. Vehicles, in general, comprise any type of vehicle having tires, such as cars, bikes, trucks, trailers, and the like.

In this context, a “pressure deviation” in a tire may be detected if the tire pressure actually determined for the tire differs from the normal tire pressure or the pressure of one or more other tires by a predetermined threshold value. Since indirect pressure monitoring systems have no tire pressure measuring possibility, the “normal” tire pressure is usually determined during a calibration phase.

The different units of the system may in one embodiment of the invention be software-implemented or hardware-implemented as separate and individual units. The system may detect pressure deviations for example based on data from sensors measuring the wheel angular velocity (as used e.g. in ABS). In most embodiments, a wheel radius analysis (WRA) unit and/or a wheel spectrum analysis (WSA) unit may be used to provide to the determination unit data for wheel-relative and/or wheel-individual pressure monitoring. The mentioned WRA modules are only an example of the more general roll radius based modules in indirect tire pressure monitoring which may be also used for the above purposes. Further data, e.g. relating to vehicle or driving conditions (including e.g. vehicle velocity, ambient temperature, load information, driving state information, etc.), may also be provided to the determination unit in some embodiments of the invention; those data may be obtained for example from the vehicle CAN bus via specific units of an indirect tire pressure monitoring system. Of course, the determination unit may also calculate tire pressure deviations based on tire pressure signals provided by direct tire pressure sensors installed within the tires.

In one embodiment a control unit is provided for realising the above features that is implemented, for instance, as a software routine, a CPU or an ECU. The control unit may in one embodiment respond to external requests and/or react to driving or vehicle conditions or detected tire pressure deviations.

The warning signal issuing unit may according to the invention perform the task of issuing the warning signal to an external unit, program or application after it has obtained from the determination unit an indication about a tire pressure deviation over a predetermined minimum time period. The external units or programs may, for instance, store the output data in a memory unit or directly alert the vehicle user about the pressure deviation. In some embodiments of the invention, the warning signal further specifies the detected pressure deviating tires, that is, the is number and position of pressure deviating tires.

A schematic diagram of an embodiment of an inventive tire pressure deviation (TPD) warning system 1 is shown in FIG. 1. The TPD warning system 1 may for example be a standardised software component which is integrated in an electronic control unit of a vehicle. The system 1 obtains data by means of an application program interface (API) 3. These obtained data may include on the one hand signals from the vehicle CAN bus e.g. describing the vehicle condition. In order to make those signals available to the different units of system 1 they are stored in a memory unit 9. On the other hand, the obtained data may include measuring data directly obtained from vehicle's sensors, such as rotational speed sensors (as existent in the vehicle's ABS) which indicate the angular velocity of the rotating wheels.

A diagnosis control unit 8 performs internal system and input signal checks and sets system status and error codes. If a severe error occurs, this unit can disable the TPD warning system.

The obtained data are input to a signal pre-processing unit 7 which pre-filters signals in order to remove disturbances and offsets and pre-computes signals and quantities used by the other units.

Then, the pre-processed signals output by the signal pre-processing unit 7 are input to a wheel radius analysis (WRA) unit 5 and a wheel spectrum analysis (WSA) unit 4. Optionally, information is input to the WRA unit 5 and the WSA unit 4 informing about special driving conditions (e.g. driving with snow chains etc.) detected by a dynamic state detector 6 based on data from the signal pre-processing unit 7 which will be considered for the data analysis.

In essence, a WRA as executed in the WRA unit 5 is based on the fact that the wheel speed of a wheel depends on the respective wheel radius: the wheel speed increases with decreasing wheel radius. Based on the wheel angular velocity signals obtained from unit 7, the WRA unit 5 estimates changes in the relative wheel radii in a subset of the vehicle's tires.

The WSA unit 4 detects changes in the spectral properties of each of the four wheel angular velocity signals. The tire pressure has significant influence on the characteristics of the spectrum of the angular velocity signal. Thus, the WSA unit 4 detects changes in the tire pressure for each wheel individually.

The combination unit 2 obtains data from the WRA unit 5 and the WSA unit 4. Based on these input data, it detects tire pressure deviations and outputs a tire pressure signal indicating a tire pressure deviation to a warning unit 10. Under certain circumstances, which will be described in more detail below, the warning unit 10 issues a warning signal to the API 3. In turn, the API 3 provides the data to external applications, such as a signalling unit installed within the driver cabin.

The warning unit 10 uses the tire pressure signal obtained from the combination unit 2 to trigger the issuance of a warning signal. The functioning of the warning unit 10 will now be described in detail with reference to FIGS. 2 to 5.

FIG. 2 shows an exemplified curve representing the variation in time of the tire pressure P as obtained from the combination unit 2. This example is directed to a tire pressure P indicating the absolute value of the tire pressure. Of course, a tire pressure signal indicating a relative deviation between two tires may be used in analogous manner. The calibration value P_{cal} is shown as a horizontal dashed line. As can be seen in FIG. 2, the tire pressure signal decreases steadily until its deviation from the calibration value P_{cal} exceeds a first threshold value ΔP₀, for instance ΔP₀=25%*P_{cal}. At that time T₀, a prior art warning unit would have issued a warning signal to the driver. According to the invention, however, the warning unit starts an internal counter that counts a minimum time period ΔTₘᵢₙ. During this minimum time period ΔTₘᵢₙ the warning unit 10 monitors the pressure signal P whether its deviation from the calibration value P_{cal} continues to exceed the first threshold value ΔP₀. If during this minimum time period ΔTₘᵢₙ the deviation has always been greater than the first threshold value ΔP₀ the warning unit 10 may issue a warning signal. Alternatively, the warning unit 10 might still continue to collect further data in order to avoid any false alarming (the length of the data collecting prolongation may be based on statistical parameters indicating the confidence level of the detected pressure deviation). If, however, the deviation of the pressure signal falls below the first threshold value ΔP₀ the counter is reset and will only be restarted if the deviation re-exceeds the first threshold value ΔP₀. Alternatively, a bi-directional counter may be used which counts in the opposite direction after the pressure signal has fallen below the first threshold value ΔP₀. Both alternative counters may also include a hysteresis so that the pressure deviation has to fall below the first threshold value ΔP₀ with some margin, e.g. 10%*P_{cal}, before the counter is reset or changes its counting direction. Both alternative counters may use a fixed or adaptive counting rate (or step). In the latter case the adaptation may depend on the deviation of the pressure signal P from the calibration value P_{cal} (the counting rate may be increased with increasing deviation) or on the signal quality (the counting rate may be decreased when the signal quality is poor) or on the vehicle speed (the counting rate may be decreased if the vehicle speed is too low or too high) or on other parameters, such as ambient temperature, etc. The bi-directional counter may also use different counting rates for the two counting directions.

Different counters with different counting rates may also be used to cancel alarm signals that have been issued after the tire pressure signal P has again fallen below the predetermined tire pressure deviation ΔP₀, in particular by the predetermined margin and/or for a predefined time. Thereby, either false warnings may be automatically cancelled once the tire pressure signal P has again indicated “normal situation” or once the tire pressure has been corrected by the driver.

Furthermore, the internal counter also counts a second maximum time period ΔTₘₐₓ starting at the time T₀ which defines the latest moment for the warning unit 10 to trigger an alarm after the pressure deviation has exceeded the first threshold value ΔP₀.

As an alternative embodiment, the pressure deviation may be further monitored within the time interval defined by ΔTₘᵢₙ and ΔTₘₐₓ by calculating the following sum:

Σ(P_{cal}−ΔP₀−P)/ΔT

wherein ΔT=t−T₀ for T₀<t≦T₀+ΔTₘₐₓ. If this sum for any t in the above time interval, i.e. for T₀+ΔTₘᵢₙT₀+ΔTₘₐₓ, exceeds some threshold, then a warning is triggered.

FIG. 3 shows a further exemplified curve of the pressure signal P which demonstrates the advantages of using the inventive warning unit 10 in comparison to a prior art warning unit. In this example the latter one would issue a false alarm but not the first one. As can be seen the pressure deviation exceeds the first threshold value ΔP₀ at T₀ and then continues to fall and stay below this value for only a limited time period. At the time T₀ the prior art warning unit would have given a false alarm whereas the inventive warning unit 10 would have not issued an alarm since the pressure deviation has fallen back below the first threshold value ΔP₀ within the minimum time period ΔTₘᵢₙ. Accordingly, a benefit of the invention is that the warning unit 10 will collect as much data as possible during the time interval ΔTₘᵢₙ in order to increase the confidence level that a low pressure situation has been detected. Preferably, ΔTₘᵢₙ is set as close as possible to ΔTₘₐₓ in order to minimize the risk of false alarms and maximize the data amount used for determining the current pressure situation. Alternatively, ΔTₘᵢₙ is chosen such that frequently occurring events (such as vehicle vibrations) or input signal anomalies which can be interpreted as pressure deviations will be effectively hindered to cause false warnings.

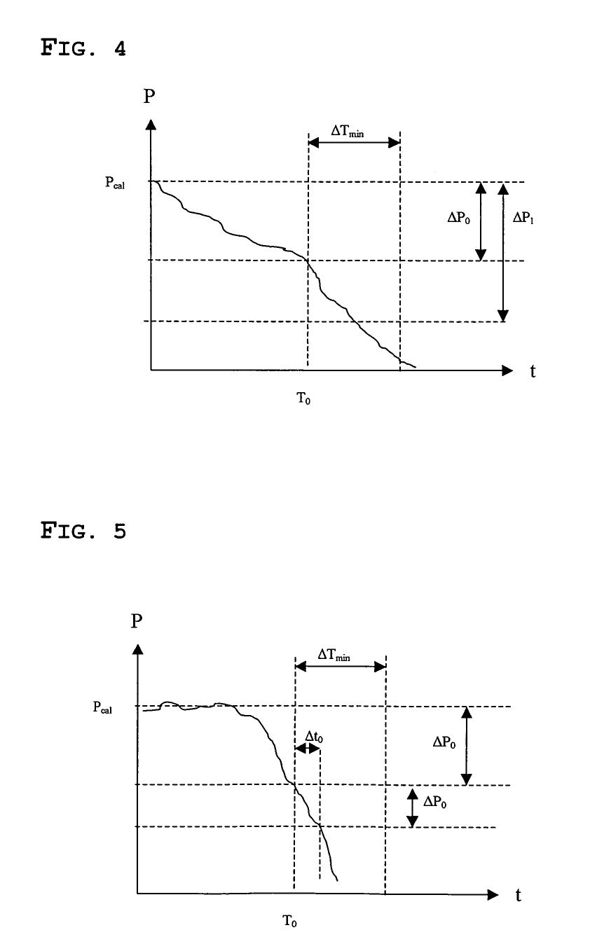

FIG. 4 shows another exemplified curve of the pressure signal P representing an exceptional situation wherein the warning unit 10 issues a warning signal within the minimum time period ΔTₘᵢₙ. This exceptional situation occurs when the pressure signal P further decreases within the minimum time is period ΔTₘᵢₙ to an extent that the pressure deviation succeeds a second threshold value ΔP₁, for instance ΔP₁=40%*P_{cal}. A further exceptional situation is shown in FIG. 5 wherein, during the minimum time period ΔTₘᵢₙ, the pressure signal P decreases with a rate greater than a predetermined rate ΔP₀/Δt₀. In this case, the warning unit 10 also issues the warning signal instantaneously after the determined rate has succeeded the predetermined rate ΔP₀/Δt₀. Thereby, different alarm types (e.g. “yellow”, “orange” and “red”, or similarly, different audio or visual alarm types) may be issued by the warning unit 10 for the three cases, namely that the first threshold value ΔP₀ is exceeded after the minimum time period ΔTₘᵢₙ, the second threshold value ΔP₁ or the predetermined rate ΔP₀/Δt₀ is exceeded within the minimum time period ΔTₘᵢₙ.

Of course, the calibration value P_{cal}, the first and second predetermined threshold values ΔP₀ and ΔP₁, the minimum and maximum time periods ΔTₘᵢₙ and ΔTₘₐₓ and the predetermined rate ΔP₀/Δt₀ may be dependent on the vehicle's velocity. For instance, the system may use calibration values P_{cal} that have been learned during a preceding calibration phase for different wheel speed intervals.

Even if the invention has been described on the basis of an embodiment applying the so-called indirect tire pressure determination, it is to be understood that the invention also applies to direct tire pressure measuring systems wherein a predetermined period of time may be waited after having detected a tire pressure deviation before issuing a warning.

1. A method of issuing a tire pressure deviation warning for a vehicle's tire, comprising:
receiving at least one vehicle signal;
determining a tire pressure signal (P) indicative of a tire pressure deviation in a vehicle's tire on the basis of the vehicle signal; and
issuing a warning signal only after the tire pressure signal (P) has indicated a predetermined tire pressure deviation (ΔP₀) for a set time period (ΔTₘᵢₙ).

2. The method according to claim 1, wherein the warning signal is issued before the tire pressure signal (P) has indicated the predetermined pressure deviation (ΔP₀) for a maximum time period (ΔTₘₐₓ), wherein the maximum time period (ΔTₘₐₓ) is longer than or equal to the set time period (ΔTₘᵢₙ).

3. The method according to claim 1, wherein the warning signal is issued within the set time period (ΔTₘᵢₙ) if the tire pressure signal (P) has indicated at least one of the following exceptional tire pressure deviation situations:
the tire pressure deviation is greater than a predetermined maximum tire pressure deviation value (ΔP₁), and
the variation in time of the tire pressure deviation is greater than a predetermined maximum tire pressure deviation variation value (ΔP₀/Δt₀).

4. The method according to claim 1, wherein the set time period (ΔTₘᵢₙ) is determined by means of a counter which is reset when the tire pressure signal (P) has fallen below the predetermined tire pressure deviation (ΔP₀).

5. The method according to claim 4, wherein the counter is reset when the tire pressure signal (P) has fallen below the predetermined tire pressure deviation (ΔP₀) by a predetermined margin.

6. The method according to claim 1, wherein the set time period (ΔTₘᵢₙ) is determined by means of a counter whose counting direction is changed each time the tire pressure signal (P) passes the predetermined tire pressure deviation (ΔP₀).

7. The method according to claim 6, wherein the counting direction is changed each time the tire pressure signal (P) has passed the predetermined tire pressure deviation (ΔP₀) by a predetermined margin.

8. The method according to claim 4, wherein the counting rate of the counter is adapted in accordance with at least one of the following:
the counting direction,
the quality of the tire pressure si al (P), and
the vehicle speed.

9. The method according to claim 1, wherein a warning signal thus issued is cancelled after the tire pressure signal (P) has fallen below the predetermined tire pressure deviation (ΔP₀), in particular by a predetermined margin.

10. The method according to claim 1, wherein the type of the warning signal to be issued depends on at least one of the two exceptional tire pressure deviation situations of
the tire pressure deviation is greater than a predetermined maximum tire pressure deviation value (ΔP₁), and
the variation in time of the tire pressure deviation is greater than a predetermined maximum tire pressure deviation variation value (ΔP₀/Δt₀) and the normal tire pressure deviation of a predetermined tire pressure deviation (ΔP₀) for a minimum set time period (ΔTₘᵢₙ).

11. A system of issuing a tire pressure deviation warning for a vehicle's tire, comprising:
an input unit (3) adapted to receive a vehicle signal;
a determination unit (2,4,5) adapted to determine a tire pressure signal (P) indicative of a tire pressure deviation in the vehicle's tire on the basis of the vehicle signal; and
a warning unit (10) adapted to issue a warning signal only after the tire pressure signal (P) has indicated a predetermined pressure deviation (ΔP₀) for a set period of time (ΔTₘᵢₙ).

12. The system according to claim 11, wherein the warning unit (10) is adapted to issue the warning signal before the tire pressure signal (P) has indicated the predetermined pressure deviation (ΔP₀) for a maximum time period (ΔTₘₐₓ), wherein the maximum time period (ΔTₘₐₓ) is longer than or equal to the minimum set time period (ΔTₘᵢₙ).

13. The system according to claim 11, wherein the warning unit (10) is adapted to issue the warning signal within the set time period (ΔTₘᵢₙ) if the tire pressure signal (P) has indicated at least one of the following exceptional tire pressure deviation situations:
the tire pressure deviation is greater than a predetermined maximum tire pressure deviation value (ΔP₁), and
the variation in time of the tire pressure deviation is greater than a predetermined maximum tire pressure deviation variation value (ΔP₀/Δt₀).

14. The system according to claim 11, wherein the warning unit (10) comprises a counter to count the set time period (ΔTₘᵢₙ) which is reset when the tire pressure signal (P) has fallen below the predetermined tire pressure deviation (ΔP₀).

15. The system according to claim 14, wherein the counter is reset when the tire pressure signal (P) has fallen below the predetermined tire pressure deviation (ΔP₀) by a predetermined margin.

16. The system according to claim 11, wherein the warning unit (10) comprises a counter to count the set time period (ΔTₘᵢₙ) whose counting direction is changed each time the tire pressure signal (P) passes the predetermined tire pressure deviation (ΔP₀).

17. The system according to claim 16, wherein the counting direction is changed each time the tire pressure signal (P) has passed the predetermined tire pressure deviation (ΔP₀) by a predetermined margin.

18. The system according to claim 14, wherein the counting rate of the counter is adapted in accordance with at least one of the following:
the counting direction,
the quality of the tire pressure signal (P), and
the vehicle speed.

19. The system according to claim 11, wherein the warning unit (10) is adapted to cancel a warning signal thus issued after the tire pressure signal (P) has fallen below the predetermined tire pressure deviation (ΔP₀), in particular by a predetermined margin.

20. The system according to claim 11, wherein the warning unit (10) is adapted to issue different types of warning signals depending on at least one of the two exceptional tire pressure deviation situations of
the tire pressure deviation is greater than a predetermined maximum tire pressure deviation value (ΔP₁), and
the variation in time of the tire pressure deviation is greater than a predetermined maximum tire pressure deviation variation value (ΔP₀/Δt₀) and the normal tire pressure deviation as claimed in claim 11 of predetermined pressure deviation (ΔP₀) for a set period of time (ΔTₘᵢₙ).

21. A computer program including program code for carrying out a method, when executed on a processing system, of issuing a tire pressure deviation warning for a vehicle's tire, comprising:
receiving at least one vehicle signal;
determining a tire pressure signal (P) indicative of a tire pressure deviation in a vehicle's tire on the basis of the vehicle signal; and
issuing a warning signal only after the tire pressure signal (P) has indicated a predetermined tire pressure deviation (ΔP₀) for a set time period (ΔTₘᵢₙ).
